(19) United States
(12) Patent Application Publication
(10) Pub. No.: US 2007/0064161 A1
(43) Pub. Date: Mar. 22, 2007

(54) Image projector

(75) Inventor: Kazuyuki Takeda, Ora-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/387,896

(22) Filed: Mar. 24, 2006

(30) Foreign Application Priority Data
Sep. 22, 2005 (JP) 2005-276038

(51) Int. Cl. H04N 9/12; G02B 7/00

(52) U.S. Cl. 348/743; 359/892

(57) ABSTRACT

An image projector comprises a light source, a first color wheel in which a first colorless light-transmitting portion and a first color filter are arranged at a first area ratio, a second color wheel in which a second colorless light-transmitting portion and a second color filter are arranged at a second area ratio different from the first area ratio, control means for rotating the first color wheel, a micromirror device which reflects a light emitted from the light source transmitted through the first color filter by the control means to form an optical image by a plurality of micromirrors, and a lens through which the light reflected by the micromirror device is projected.

### CROSS-REFERENCE TO RELATED APPLICATIONS

This application is based upon and claims the benefit of priority from Japanese Patent Application No. 2005-276038, filed Sep. 22, 2005, the entire contents of which are incorporated herein by reference.

### BACKGROUND

1. Field

One embodiment of the invention relates to an image projector useful for a digital light processing (DLP) color projector.

2. Description of the Related Art

In a DLP color projector, light emitted from a white light source is transmitted sequentially through filters of R (red), G (green), B (blue) provided at a rotating color wheel and irradiated onto a panel surface of a digital micromirror device (DMD).

In synchronization with light beams supplied sequentially from R, G, B filters by time division, optical images corresponding to the light beams of R, G, B are formed by reflection of a number of micromirrors, on the panel surface of the DMD. The optical images of R, G, B formed on the DMD are magnified and projected on a screen through a projection lens and color images are thereby displayed on the screen.

Incidentally, in the DLP color projector, a W (white) filter which serves as a colorless light transmitter is used besides R, G, B filters, on the color wheel, to enhance brightness of displayed images.

By sequentially irradiating R, G, B, W light beams onto the panel surface of the DMD by time division, W light beam is reflected to the projection lens by all of the micromirrors and the brightness can be thereby enhanced.

If the W filter is thus used, the brightness can be enhanced in accordance with the area of the filter. However, since the area of the R, G, B filters is reduced, deterioration of color purity and color saturation cannot be avoided.

The deterioration of color saturation is caused by a fact that since brightness on a light-colored part having high brightness is optically enhanced, the color of the colored object in a scene including a white background is recognized as compared with white color of the background and the colored portion seems dark due to characteristics of human eyes. In other words, vividness of color seems lost due to visual influence of white color.

To sum up, brightness and color tone of the projected image have contradictory characteristics. For this reason, use of either a color wheel having brightness of the projected image with priority or a color wheel having color tone with priority should be determined in response to user's various requests for image qualities.

Jpn. Pat. Appln. KOKAI Publication No. 2004-354957 discloses an invention having a first and a second color filter of red, green, blue and white light transmission areas arranged coaxially to change setting of brightness and setting of color tone by rotating the color filters.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 schematically illustrates a DLP color projector according to an embodiment of the present invention;

FIG. 2 illustrates an example of an optical engine in the DLP color projector according to the embodiment;

FIG. 3A illustrates characteristics of a color wheel used in the optical engine according to the embodiment;

FIG. 3B illustrates characteristics of a color wheel used in the optical engine according to the embodiment;

FIG. 4 illustrates phase control of two color wheels according to the embodiment;

FIG. 5 illustrates another example of arrangement of two color wheels according to the embodiment; and

FIG. 6 illustrates a modified example of the color wheels according to the embodiment.

### DETAILED DESCRIPTION

Various embodiments according to the invention will be described hereinafter with reference to the accompanying drawings. In general, according to one embodiment of the invention, an image projector comprises a light source a first color wheel in which a colorless light-transmitting portion and a color filter are arranged at a first area ratio a second color wheel in which a colorless light-transmitting portion and a color filter are arranged at a second area ratio different from the first area ratio control means for rotating one of the first and second color wheels to allow light emitted from the light source to transmit through the color filter a micromirror device which reflects the light transmitted through the color filter of the first or second color wheel by the control means to form an optical image by a plurality of micromirrors and a lens through which the light reflected by the micromirror device is projected.

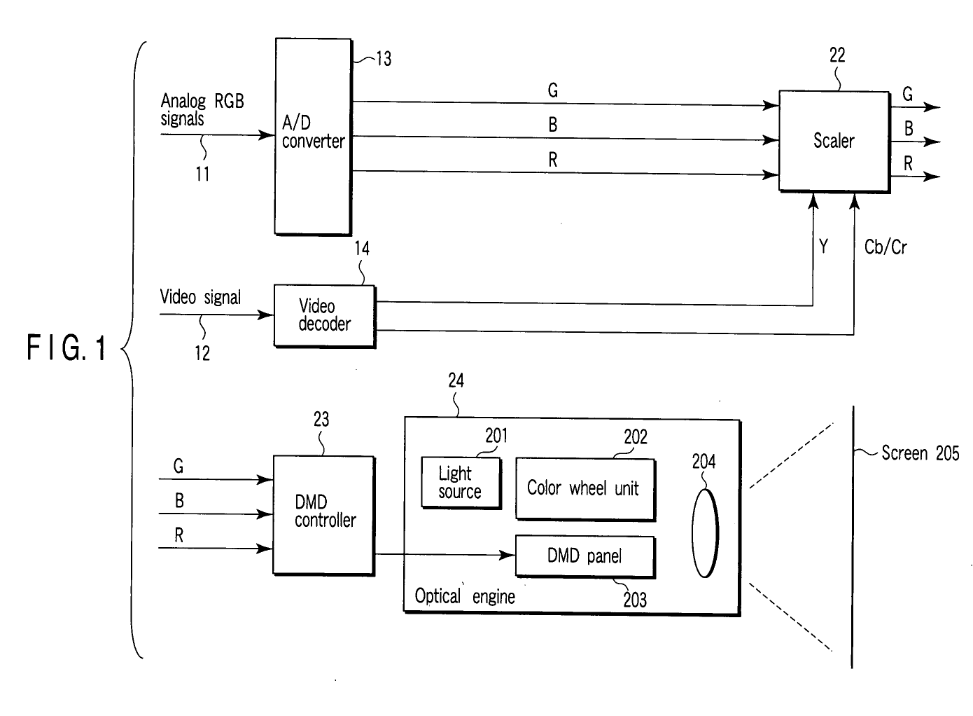

Embodiments of the present invention will be explained below with reference to the accompanying drawings. FIG. 1 schematically illustrates a DLP color projector according to an embodiment of the present invention. An analog R, G, B signal is input to an input unit 11 and led to an analog-digital (A/D) converter 13. The A/D converter 13 digitizes the input R, G, B signal and outputs the digitized signals to a scaler 22.

A video signal is led to an input unit 12 and then to a video decoder 14. The video decoder 14 obtains digital brightness signal Y and color-difference signal Cb/Cr from the input video signal and supplies the signals to the scaler 22. The scaler 22 selectively receives image signals R, G, B or image signals Y, Cb/Cr. A selector is provided in the input unit 22 though not shown.

The scaler 22 serves a panel driver which drives a DMD panel 203 together with a DMD controller 23 of a subsequent stage.

In other words, the scaler 22 obtains R, G, B pixel signals corresponding to resolution (number of pixels) of the DMD panel 203, matching the resolution of the input image signals and the resolution of the DMD panel 203. In other words, the scaler 22 adjusts the number of pixels of the input image signals such that the input image signals are suitable for a plurality of micromirrors (plural pixels) of the DMD panel 203.

The R, G, B pixel signals output from the scaler 22 are input to the DMD controller 23. The DMD controller 23 generates a W pixel signal corresponding to a W filter provided at color wheels to be explained later. Then the DMD controller 23 supplies the input R, G, B pixel signals and the generated W pixel signal to the DMD panel 203 provided in an optical engine 24 by time division.

Besides the DMD panel 203, the optical engine 24 comprises a light source 201, a color wheel unit 202, a projection lens 204, etc. and functions to project images to a screen 205.

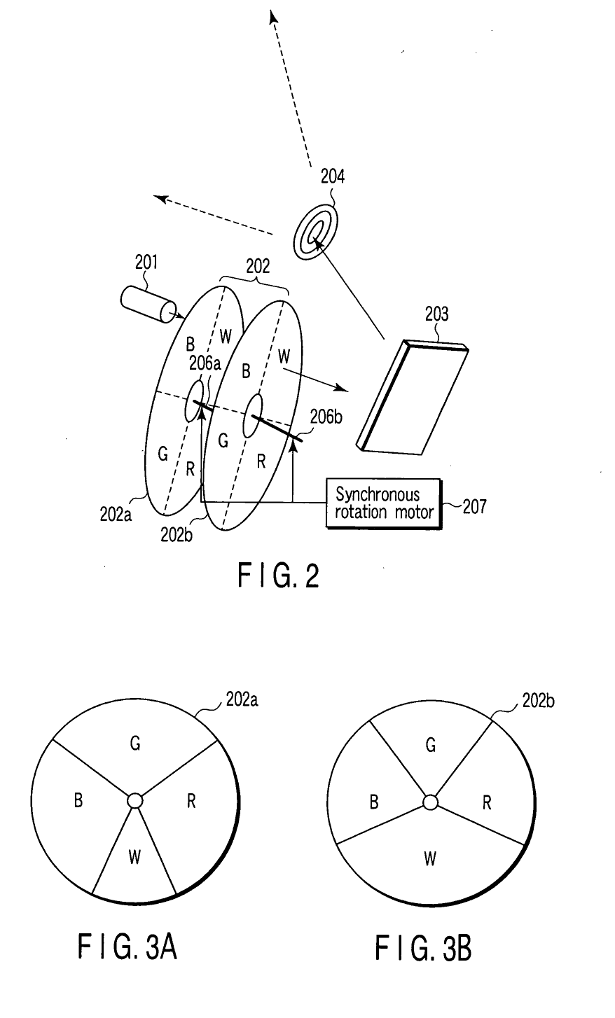

FIG. 2 illustrates details of the structure of the optical engine 24. The light emitted from the light source 201 is transmitted through the color wheel unit 202 and irradiated onto a micromirror array surface of the DMD panel 203.

In this case, the color wheel unit 202 comprises two color wheels 202a, 202b. The color wheels are different in characteristics and each of them has R, G, B, W filters. The details of the color wheels will be explained later. The color wheels 202a, 202b overlap each other so as to be rotatably supported by coaxially provided rotary shafts 206a, 206b, respectively.

The color wheels 202a, 202b are selectively rotated by a synchronous rotation motor 207. The user can select rotation of either of the color wheels by operating a change-over switch (not shown) provided on a color projector.

The W filter of the stopped color wheel 202a or 202b is controlled to be at a position where the light emitted from the light source 201 is transmitted. Thus, the light emitted from the light source 201 is transmitted sequentially through the R, G, B, W filters of the rotated color wheel and irradiated onto the DMD panel 203.

On the DMD panel 203, direction of reflection of each micromirror is switched by time division in accordance with the R, G, B pixel signals and the W pixel signal such that the incident light is reflected to the projection lens 204 as colored image light.

In synchronization with operation of each micromirror of the DMD panel 203 corresponding to the R, G, B pixel signals and the W pixel signal, the color wheel 202a or 202b requested to rotate is controlled to rotate by the synchronous rotation motor 207 such that the light transmitted through the R, G, B, W filters is irradiated onto the DMD panel 203 by time division. Thus, the image light reflected on the DMD panel 203 is magnified and emitted through the projection lens 204 and projected onto the screen 205.

FIG. 3A, FIG. 3B illustrate examples of the color wheels 202a, 202b, respectively. Each of the color wheels 202a, 202b has four filters of R, G, B, W. In accordance with the area of the W filter serving as a colorless light transmission unit, brightness or color tone of the projected image is considered with priority.

In other words, the area of the W filter is smaller than the areas of the R, G, B filters in the color wheel 202a shown in FIG. 3A. In this case, the color tone is considered with priority.

On the other hand, the area of the W filter is greater than the areas of the R, G, B filters in the color wheel 202b shown in FIG. 3B. In this case, the brightness is considered with priority.

Thus, balance of the color tone and the brightness can be varied by changing a ratio of the area of the W filter to the areas of the R, G, B filters. The ratio of areas of the filters in the color wheels can be arbitrarily set as occasion requires and various characteristics can be obtained.

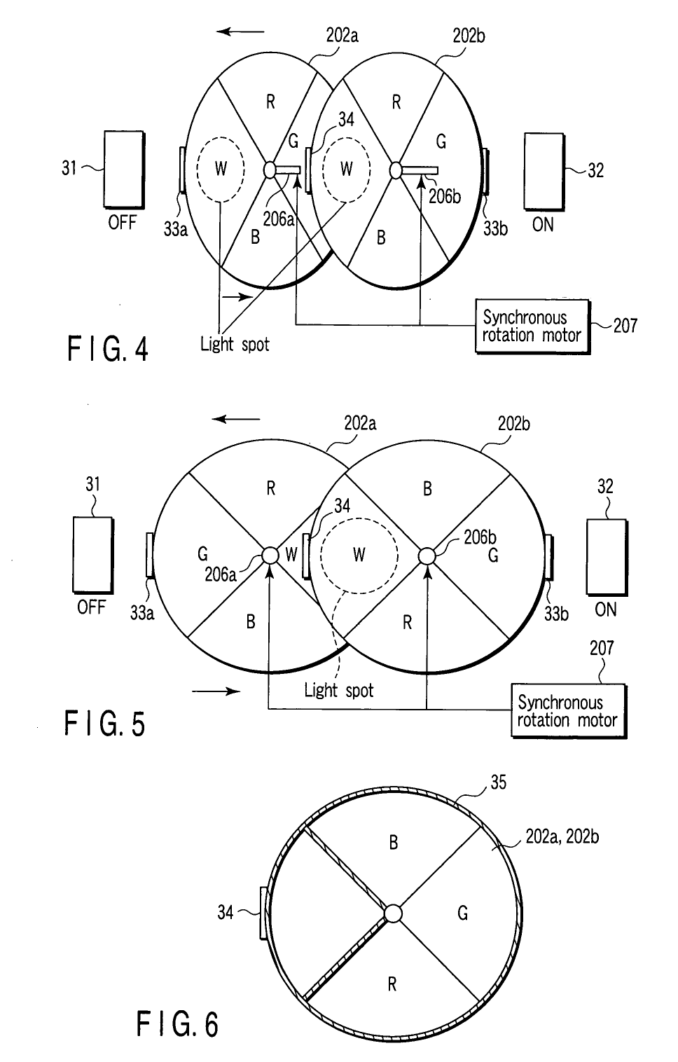

FIG. 4 illustrates an example of stopping the W filter of the color wheel which is not rotated, of the color wheels 202a and 202b, at a position where the light emitted from the light source 201 is transmitted.

For example, if the user selects use of the color wheel 202a which has brightness with priority, the user needs to execute phase control to stop the W filter at a position where the light emitted from the light source 201 is transmitted.

In this case, a ferromagnetic member 33b of iron, etc. is provided at a predetermined position of an outer periphery of the color wheel 202b (for example, on the G filter side). A magnetic unit 32 is provided in the vicinity of the outer periphery of the color wheel 202b. By energizing and turning on the magnetic unit 32, the magnetic unit 32 can attract the ferromagnetic member 33b and the phase control can be executed such that the color wheel 202b is stopped at the position where the light emitted from the light source 201 is transmitted through the W filter of the color wheel 202b.

Since the ferromagnetic member 33b is provided on the color wheel 202b, the wheel balance may be lost and vibration may be caused. To prevent this, rotary balance is adjusted by providing a balancer 34 having the same weight as the ferromagnetic member 33b on an opposite phase side to the portion of the color wheel 202b where the ferromagnetic member 33b is provided.

Thus, the phase of the color wheel 202b is controlled and the light emitted from the light source 201 (represented as a light spot in the figure) is controlled to transmit through the W filter.

On the other hand, a ferromagnetic member 33a is provided on the outer periphery of the color wheel 202a and a magnetic unit 31 is provided in the vicinity of outer periphery of the color wheel 202a. Therefore, when the user selects the color wheel 202b, the magnetic unit 31 attracts the ferromagnetic member 33a by energizing and turning on the magnetic unit 31 and the phase control can be executed such that the color wheel 202a is stopped at the position where the light emitted from the light source 201 is transmitted through the W filter of the color wheel 202a.

In this case, a balancer (not shown) is also provided on an opposite phase side to the portion of the color wheel 202a where the ferromagnetic member 33a is provided, similarly to the color wheel 202b.

According to the above-described embodiment, two color wheels 202a, 202b having different characteristics are set coaxially, one of the color wheels 202a, 202b is rotated for image display and the other color wheel is stopped at the position where the light emitted from the light source 201 is transmitted through the W filter of the other color wheel. Therefore, image quality can be easily changed in a very simple structure.

FIG. 5 illustrates another example of arrangement of the color wheels 202a, 202b. Elements like or similar to those shown in FIG. 4 are denoted by similar reference numbers. The rotary shafts 206a, 206b of the color wheels 202a, 202b are arranged parallel such that the color wheels 202a, 202b partially overlap each other. The light emitted from the light source 201 is irradiated to the overlapped portion of the color wheels 202a, 202b.

In this case, phase control is executed such that the color wheel 202a or 202b that is not rotated is stopped at the position where the light emitted from the light source 201 is transmitted through the W filter of the color wheel, by the ferromagnetic member 33a or 33b and the magnetic unit 31 or 32, as explained with FIG. 4.

A light-transmitting member formed of a colorless transparent glass or the like is used as the W filters of the color wheels 202a, 202b. However, the optical transmittance becomes ideal by removing the light-transmitting members and forming space at the W filter portions as shown in FIG. 6, and degradation of the brightness can be prevented even if a plurality of color wheels are overlapped.

Furthermore, if the color wheel is stopped and light is irradiated thereto, the color wheel itself is heated, but this problem can be solved.

To prevent degradation of the mechanical strength which is caused by removing the light-transmitting members at the W filter portions, the outer peripheries of the R, G, B filters and the outer periphery of the W filter portion can be reinforced by a reinforcing ring 35. The weight balance of the color wheels 202a, 202b is varied by removing the light-transmitting members. Thus, the balancer 34 can be provided at a position in axial symmetry with the removed W filter portion, on the reinforcing ring 35.

In the embodiment, two color wheels 202a, 202b are used but a plurality of color wheels can also be used. In this case, the plural color wheels can be selectively moved to a position where the light emitted from the light source 201 is irradiated, by a changer (not shown).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image projector comprising:
a light source;
a first color wheel in which a first colorless light-transmitting portion and a first color filter are arranged at a first area ratio;
a second color wheel in which a second colorless light-transmitting portion and a second color filter are arranged at a second area ratio different from the first area ratio;
control means for rotating the first color wheel;
a micromirror device which reflects a light emitted from the light source transmitted through the first color filter by the control means to form an optical image by a plurality of micromirrors; and
a lens through which the light reflected by the micromirror device is projected.

2. The image projector according to claim 1, wherein the control means coaxially arranges a first rotary shaft of the first color wheel and a second rotary shaft of the second color wheel; and
the control means stops the second color wheel at a position where the light emitted from the light source is transmitted through the second colorless light-transmitting portion.

3. The image projector according to claim 1, wherein the control means arranges a first rotary shaft of the first color wheel and a second rotary shaft of the second color wheel in parallel to allow the first and second color wheels to partially overlap each other; and
the control means stops the second color wheel at a position where the light emitted from the light source is transmitted through the second colorless light-transmitting portion.

4. The image projector according to claim 2, further comprising:
a first magnetic member provided on a first outer periphery of the first color wheel;
a first magnetic unit provided near the first outer periphery of the first color wheel and energized to execute phase control, thereby attracting the first magnetic member;
a second magnetic member provided on a second outer periphery of the second color wheel; and
a second magnetic unit provided near the second outer periphery of the second color wheel and energized to execute phase control, thereby attracting the second magnetic member and stopping the second color wheel at the position where the light emitted from the light source is transmitted through the second colorless light-transmitting portion of the second color wheel.

5. The image projector according to claim 3, further comprising:
a first magnetic member provided on a first outer periphery of the first color wheel;
a first magnetic unit provided near the first outer periphery of the first color wheel and energized to execute phase control, thereby attracting the first magnetic member;
a second magnetic member provided on a second outer periphery of the second color wheel; and
a second magnetic unit provided near the second outer periphery of the second color wheel and energized to execute phase control, thereby attracting the second magnetic member and stopping the second color wheel at the position where the light emitted from the light source is transmitted through the second colorless light-transmitting portion of the second color wheel.

6. The image projector according to claim 4, further comprising:
a first balancer provided on an opposite phase side to the first magnetic member, on the first outer periphery of the first color wheel; and
a second balancer provided on an opposite phase side to the second magnetic member, on the second outer periphery of the second color wheel.

7. The image projector according to claim 5, further comprising:
a first balancer provided on an opposite phase side to the first magnetic member, on the first outer periphery of the first color wheel; and
a second balancer provided on an opposite phase side to the second magnetic member, on the second outer periphery of the second color wheel.

8. The image projector according to claim 1, wherein each of the first and second colorless light-transmitting portions is formed of a colorless transparent filter.

9. The image projector according to claim 1, wherein each of the first and second colorless light-transmitting portions is formed as space.

10. The image projector according to claim 9, wherein first and second reinforcing rings are provided on the first and second outer peripheries of the first and second color wheels.

11. The image projector according to claim 9, wherein each of the first and second color wheels comprises first and second balancers at a position which is in axial symmetry with each of the first and second colorless light-transmitting portions.

12. The image projector according to claim 1, wherein each of the first and second color filters includes a red filter, a green filter and a blue filter.

13. An image projector comprising:
a light source;
a plurality of color wheels, each of which includes color filter and has different characteristics;
control means for rotating a predetermined color wheel of the plurality of color wheels;
a micromirror device which reflects a light emitted from the light source transmitted through a predetermined color filter of the predetermined color wheel by the control means to form an optical image by a plurality of micromirrors; and
a lens through which the light reflected by the micromirror device is projected.

14. An image projection method comprising:
rotating one of first and second color wheels that include first and second color filters, respectively, and have different characteristics; and
reflecting a light emitted from a light source transmitted through one of the first and second color filters to form an optical image by a plurality of micromirrors, and projecting the reflected light through the lens.

15. The image projection method according to claim 14, comprising:
arranging first and second rotary shafts of the first and second color wheels coaxially; and
stopping the other one of the first and second color wheels at a position where the light emitted from the light source is transmitted through the other one of first and second colorless light-transmitting portions of the first and second color wheels.

16. The image projection method according to claim 14, comprising:
arranging first and second rotary shafts of the first and second color wheels and the second rotary shaft of the second color wheel in parallel to allow the first and second color wheels to partially overlap each other; and
stopping the other one of the first and second color wheels at a position where the light emitted from the light source is transmitted through the other one of first and second colorless light-transmitting portions of the first and second color wheels.
